(19) United States
(12) Patent Application Publication
(10) Pub. No.: US 2003/0160447 A1
(43) Pub. Date: Aug. 28, 2003

(54) Double containment pipe system

(76) Inventors: Michael W. Stark, Beavercreek, OH (US); Gregory A. Jackson, Centerville, OH (US)

Correspondence Address: A PATENT LAWYER CORP, PC, R WILLIAM GRAHAM, 22 S ST CLAIR ST, DAYTON, OH, 45402, US

(21) Appl. No.: 10/085,985

(22) Filed: Feb. 28, 2002

(51) Int. Cl. F16L 3/00

(52) U.S. Cl. 285/123.1; 285/123.15; 285/133.11

(57) ABSTRACT

A double containment pipe system includes a carrier pipe section having a plurality of radially spaced members fixably connected to and longitudinally extending along an outer surface thereof, a containment pipe section having an inner surface of a diameter to contain said carrier pipe and readily permit movement therein, wherein an annulus is formed between the carrier pipe section and containment pipe section. Further, a plurality of carrier pipe sections as defined and are fixably interconnected and which are operably disposed within a plurality of the containment pipe sections which are removably interconnected. The containment pipe sections are removably interconnected by a quick connect coupling having a clamp configured to sealably enclose and connect adjacent ends of the connecting containment pipes.

### BACKGROUND OF THE INVENTION

1. Field of the Invention

This invention relates to double containment pipes and to methods for using the same.

2. Related Art

When dealing with potentially toxic fluids, there is commonly employed a double containment pipe system in which an inner carrier pipe (commonly referred to as the “carrier pipe”) is co-axially placed within an outer secondary containment pipe. These are usually employed in nuclear, oil and gas, petroleum refining and chemical processing industries.

The carrier pipe is used to transport hazardous or toxic fluid while the containment pipe is used to contain a leak from the carrier pipe. With respect to transport and containment of such fluids, it is of great significance to detect and contain any fuel leaks from subterranean pipes which connect one or more storage tanks to dispensing pumps in the installation. It is thus common to provide leak detector lines within the annulus between the supply containment pipes.

These prior systems typically employ a separate ring-like centralizer which is disposable about the carrier pipe to support the carrier pipe within the containment pipe. The centralizer is configured to have a gap for a leak detector line and to allow flow in the containment pipe to pass thereby. The installation of these double containment pipes is difficult due to the ability to move the carrier pipe within the containment pipe. The centralizer can also bind between the two pipes or moves in a way which can affect the leak line detection operation. Thus, this makes it difficult to slide the respective pipes into a position which they can be connected. This increases the amount of time, and hence the cost, of assembling the installation. In addition, when installing such a system, it is important to ensure that the fuel carrier pipes remain spaced from the containment pipes and do not block the passage of leaked fuel to a leak detection system.

### BRIEF SUMMARY OF THE INVENTION

It is an object of the invention to improve containment of hazardous materials.

It is another object to ease installation of double containment pipe.

It is yet another object to improve the design of double containment pipe.

It is still a further object to reduce the cost of installing double containment pipe.

It is another object to improve movement of the carrier pipe within the containment pipe without binding occurring.

Accordingly, the present invention is directed to a double containment pipe system. The system includes a carrier pipe section having a plurality of radially spaced members connected to and longitudinally extending along an outer surface thereof. A containment pipe section is provided having an inner surface of a diameter to contain said carrier pipe and readily permits movement therein. An annulus is formed between the carrier pipe section and containment pipe section. Further, the invention calls for a plurality of carrier pipe sections as defined which are fixably interconnected and which are operably disposed within a plurality of the containment pipe sections which are removably interconnected. The containment pipe sections are removably interconnected by a quick connect coupling having a clamp configured to sealably enclose and connect adjacent ends of the connecting containment pipes. A leak detection device, such as electrical wires equipped with sensors, are operably disposed within the annulus.

Other objects and advantages will be readily apparent to those skilled in the art upon viewing the drawings and reading the detailed description hereafter.

### BRIEF DESCRIPTION OF THE DRAWINGS

FIG. 1 is a partial cut-away perspective view of a double containment pipe system of the present invention;

FIG. 2 is another part cut-away expanded sectional view the double containment pipe system.

FIG. 3 is an end view of the double containment pipe system with the leak detection disposed therein; and

FIG. 4 is an end view of another embodiment of the double containment pipe system with the leak detection disposed therein is an end view of a double containment pipe.

FIG. 5 is a part sectional view of a clamp used with the invention.

FIG. 6 is a part sectional view of another clamp and containment pipe used with the invention.

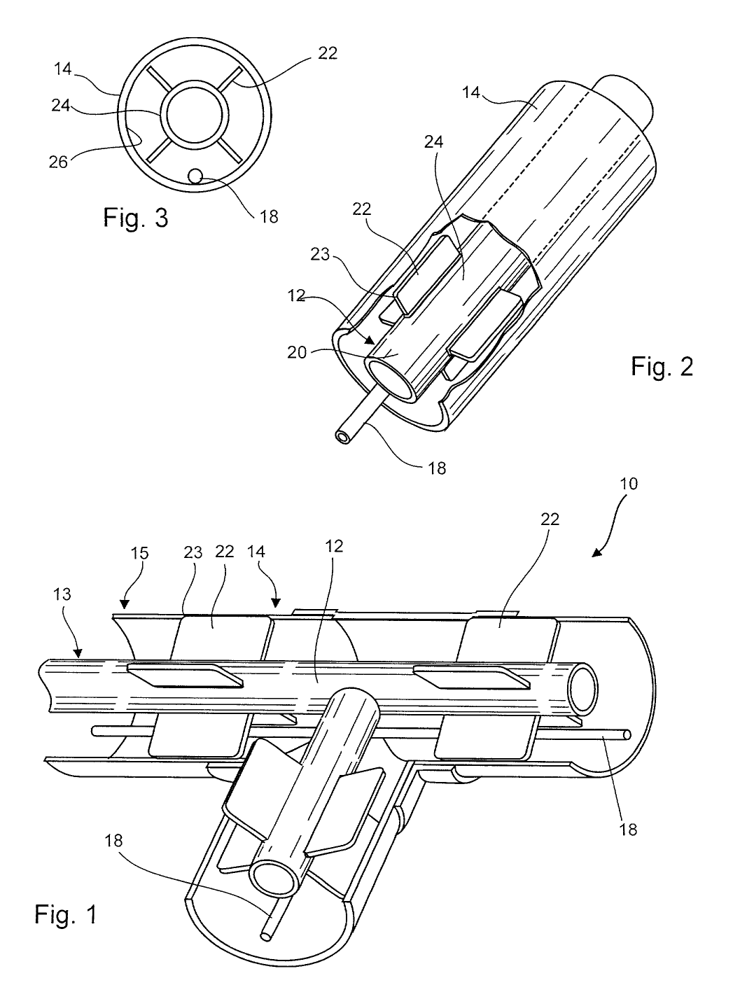

### DETAILED DESCRIPTION OF THE INVENTION

Referring to the drawings, the double containment pipe system is generally referred to by the numeral 10. This double containment pipe system 10 includes a plurality of carrier pipe sections 12 (collectively referred to as “the carrier pipe 13”), containment pipe sections 14 (collectively referred to as “the containment pipe 15”), clamps 16 and leak detection device 18. The double containment pipe system 10 contains the carrier pipe 13 within the containment pipe 15. The purpose of the containment pipe 15 is to contain any leakage from the carrier pipe 13 and to assist the leak detection device 18 in the detection of such leakage.

The term “pipe section” refers to a tubular member of any geometry which carries out the principles of the invention described herein. Also, the pipe sections 12 and 14 and clamp 16 can be made of a predetermined material which is made for carrying and/or containing an intended fluid in an optimized manner, for example, metal, plastic, fiberglass reinforced plastic (FRP) or combination thereof. The pipe sections 12 and 14 and clamps 16 are ordinarily rigid, but may be flexible or a combination thereof.

More particularly, the carrier pipe section 12 includes a generally cylindrical member 20 having a plurality of longitudinally extending fins (centralizers) 22. The centralizer fins 22 are configured to extend radially outward from an outer surface 24 of the carrier pipe section 12 at approximately equidistant distances from one another and are preferably fixed to the outer diameter of the carrier pipe 12. For example, in the case of three fins 22, the separation is about 60 degrees from one another and in the case of four fins 22, the separation is about 45 degrees. The fins 22 need not extend the entire length of the carrier pipe section 12 and there can be two or more longitudinally spaced sets of fins 22 on a single carrier pipe section 12. An outer diameter formed by the fins 22 should be less than the inner diameter of the inner surface 26 of the containment pipe section 14 as seen in FIG. 3.

The fins 22 provide a bearing surface which more readily enables the movement of one pipe section 12 to another pipe section 14. This is particularly so when installing the carrier pipe 13 and containment pipe 15 and the interconnected pipe sections, for example, must be pulled into position for interconnecting. Also, the fins 22 can be formed with an arcuate corner 23 to aid in longitudinal movement between the pipe sections 12 and 14.

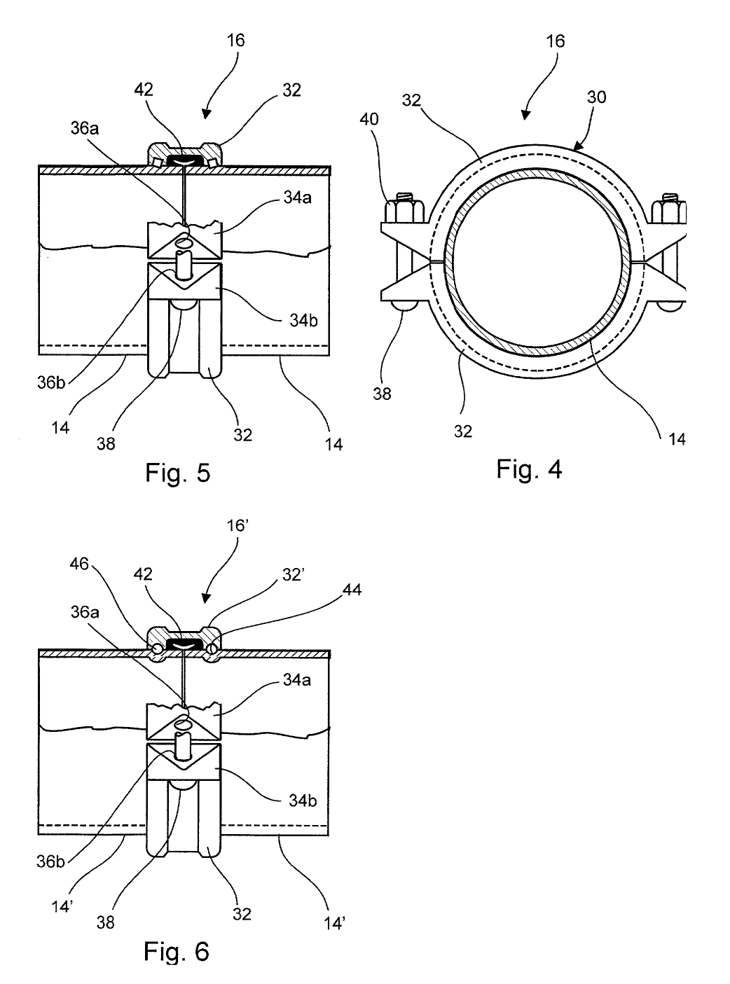

As seen in FIGS. 3 and 4, the leak detection device 18 is designed to be preferably disposed adjacent a bottom portion of the containment pipe 15 so that a position of the leak can be readily detected and repair made. As it would become apparent to one skilled in the art, an annulus 28 formed between the inner surface 26 and outer surface 24 can vary in size to accomplish the purpose intended herein. Thus, by disposing the detection device 18 at the bottom as shown, a small amount of leakage from the carrier pipe 13 will run to the bottom portion of the containment pipe 15, and the point at which the leak occurred will be relatively accurately detected. Further, the fins 22 aid in maintaining the leak detection device 18 at the bottom when having to replace damaged sections of the system 10.

The clamp 16 serving as the containment coupling includes a circumferentially adjustable enclosure 30 having two generally C-shaped portions 32 (which optionally could be formed generally cylindrically having a lengthwise separation), and includes flanged portions 34a and 34b. The flange portions 34a and 34b each have a respective coaxial bore 36a and 36b to receive a bolt 38 therethrough. A nut 40 can be used to tighten and lock the enclosure 30 about respective adjacent ends of containment pipe sections 14. A conformable seal 42 is provided between the enclosure 30 and the ends of the containment pipe section 14.

Assembly of the double containment pipe system 10 is as follows. The carrier pipe sections 12 are slidably positioned such that the ends thereof abut and are connected by welding the two ends together as is known in the art. The clamp 16 is positioned about one end of a first pipe section 14 in slid down sufficiently to enable another end of a second containment pipe 14 to be positioned adjacent the end of the first containment pipe 14. The clamp 16 can be slid over the abutment of the ends of the pipe section 14 and the clamp 16 tightened to provide a sealed double containment not here before known. Alternatively, the C-shaped portions 32 can be positioned about the ends of containment pipe 14 and connected to each other once the ends abut.

An advantage of any of the aforementioned embodiments is that a double containment pipe system can be readily assembled. Another advantage is that the double containment pipe system is inexpensively assembled. Specifically, by providing the present invention, rather than requiring welding or gluing all ends of containment pipe sections, only the carrier pipe sections need be welded. This reduces the total man hours required for installation in thus reduces the cost.

The containment pipe sections described herein can also be connected together using other couplers which are known in the art. To facilitate connection of the supply pipes, it is necessary to have the supply pipes extend beyond the containment pipes. Optionally, one end of a pipe section can be joined to another end in the form of a male-female relation.

FIG. 6 shows another clamp 16′ for use with another containment pipe 14′ of the present invention. Here, the ends of the containment pipe 14′ are formed with a recessed groove 44 to receive seal 46 of the clamp 16′.

The invention has been described in certain specific embodiments, many additional modifications and variations will be apparent to those skilled in the art. It is, therefore, understood that within the scope of the appended claims, this invention may be practiced otherwise than specifically described. For example, it is contemplated that other arrangements of the fins can be formed between these carrier pipe and containment and these should be included within the invention. It might be that the fins need not be directly attached to either pipe section, but it is conceived that potentially less desirable sleeves having the fins connected thereto could be employed wherein the sleeves are fixed axially via welding, for example, to the pipe. Accordingly, the claims appended hereto should be read in their full scope including any such modifications, derivations and variations.

What is claimed is:

1. A double containment pipe system, which includes:
a carrier pipe section having a plurality of radially spaced members connected to and longitudinally extending along an outer surface thereof; and
a containment pipe section having an inner surface of a diameter to contain said carrier pipe and readily permit movement therein, wherein an annulus is formed between the carrier pipe section and containment pipe section.

2. The double containment pipe system of claim 1, wherein said radially spaced members are centralizer fins.

3. The double containment pipe system of claim 1, wherein said radially spaced members are generally radially equidistantly spaced from one another.

4. The double containment pipe system of claim 1, which includes a plurality of said carrier pipe sections as defined which are fixably interconnected and which are operably disposed within a plurality of said containment pipe sections which are removably interconnected to one another.

5. The double containment pipe system of claim 4, wherein said containment pipe sections are removably interconnected by a quick connect coupling having a clamp configured to sealably enclose and connect adjacent ends of said connecting containment pipe sections.

6. The double containment pipe system of claim 1, which includes a leak detection device operably disposed within an annulus between said carrier pipe section and said containment pipe section adjacent a bottom portion of said containment pipe between said radially extending members.

7. The double containment pipe system of claim 1, wherein said radially spaced members are fixably connected to said carrier pipe section.

8. The double containment pipe system of claim 1, wherein said radially spaced members are fixed axially with respect to one of said pipes.

9. A double containment pipe system, which includes:
a carrier pipe section; and
a containment pipe section having a plurality of radially spaced members fixably connected to and longitudinally extending along an inner surface thereof, wherein an inner diameter formed by said radially spaced members to readily movably contain said carrier pipe, and wherein an annulus is formed between the carrier pipe section and containment pipe section which contains said radially spaced members.

10. The double containment pipe system of claim 9, wherein said radially spaced members are fins.

11. The double containment pipe system of claim 9, wherein said radially spaced members are generally radially equidistantly spaced from one another.

12. The double containment pipe system of claim 9, which includes a plurality of said carrier pipe sections as defined which are fixably interconnected and which are operably disposed within a plurality of said containment pipe sections which are removably interconnected to one another.

13. The double containment pipe system of claim 12, wherein said containment pipe sections are removably interconnected by a quick connect containment coupling having a clamp configured to sealably enclose and connect adjacent ends of said connecting containment pipe sections.

14. The double containment pipe system of claim 9, which includes a leak detection device operably disposed within an annulus between said carrier pipe section and said containment pipe section adjacent a bottom portion of said containment pipe between said radially extending members.

15. The double containment pipe system of claim 9, wherein said radially spaced members are fixed axially with respect to one of said pipes.
